(19) United States
(12) Patent Application Publication
(10) Pub. No.: US 2017/0072439 A1
(43) Pub. Date: Mar. 16, 2017

(54) Nozzle for a Vacuum Pump or Truck

(71) Applicant: Hydro International plc, Clevedon (GB)

(72) Inventor: Jerome Mims, Sanford, FL (US)

(21) Appl. No.: 15/245,983

(22) Filed: Aug. 24, 2016

Related U.S. Application Data
(60) Provisional application No. 62/218,354, filed on Sep. 14, 2015.

(51) Int. Cl. B08B 9/08; A47L 9/02

(52) U.S. Cl. CPC B08B 9/0856; A47L 9/02

(57) ABSTRACT

A vacuum nozzle for a vacuum pump or truck, the vacuum nozzle comprising: a vacuum conduit configured to be connected to a vacuum source; a primary inlet fluidically connected to the vacuum conduit for receiving flow under suction; and a secondary inlet fluidically connected to the vacuum conduit for receiving flow under suction, the secondary inlet being positioned upstream of the primary inlet so as to allow flow to bypass the primary inlet, thereby preventing the primary inlet from sealing against a surface under suction.

### TECHNICAL FIELD

The invention relates to a nozzle for a vacuum pump or truck which may, for example, be used to extract solids, such as grit and sand, from a wastewater treatment tank.

### BACKGROUND

A vacuum truck may be used to periodically remove solids, liquids, sludge or slurry from a tank, such as a wastewater treatment tank in order to ensure that the tank is able to properly perform its function. The vacuum truck comprises a pump (or a standalone pump may be used) that provides suction to a hose which is inserted into the tank in order to provide extraction during a cleanout operation. However, conventionally, when the suction end of the hose touches the floor of the tank, the suction causes the hose to lock to the floor, thus preventing solids from entering the hose. Consequently, the process needs to be stopped and the hose dislodged before vacuuming can continue. This can happen repeatedly during a cleanout operation which increases extraction time and operator input.

The invention seeks to provide a nozzle for a vacuum pump or truck which addresses the above problems.

### SUMMARY

In accordance with an aspect of the invention there is a provided a vacuum nozzle for a vacuum pump or truck, the vacuum nozzle comprising: a vacuum conduit configured to be connected to a vacuum source; a primary inlet fluidically connected to the vacuum conduit for receiving flow under suction; and a secondary inlet fluidically connected to the vacuum conduit for receiving flow under suction, the secondary inlet being positioned upstream of the primary inlet so as to allow flow to bypass the primary inlet, thereby preventing the primary inlet from sealing against a surface under suction.

The secondary inlet may open towards the primary inlet.

The secondary inlet may be formed by a passage which extends towards the primary inlet.

The passage may be substantially parallel to the vacuum conduit.

The area of the primary inlet may be greater than the area of the secondary inlet.

The vacuum nozzle may further comprise a head connected to the vacuum conduit, wherein a distal end of the head forms the primary inlet.

Opposing side surfaces of the head may diverge from one another from the vacuum conduit towards the distal end.

The secondary inlet may be formed in one or both of the side surfaces.

The nozzle may comprise a pair of secondary inlets.

The secondary inlets may be offset either side of the vacuum conduit.

The vacuum nozzle may further comprise one or more poles which extend across the head adjacent the vacuum conduit.

The poles may be removably connected to the head. For example, the poles may be formed by bolts which extend through the head.

### BRIEF DESCRIPTION OF THE DRAWINGS

For a better understanding of the invention, and to show more clearly how it may be carried into effect, reference will now be made, by way of example, to the accompanying drawings, in which:

FIG. 1 is a perspective view of a vacuum nozzle according to an embodiment of the invention;

FIG. 2 is a front view of the vacuum nozzle;

FIG. 3 is a side view of the vacuum nozzle;

FIG. 4 is a bottom view of the vacuum nozzle; and

FIG. 5 is a cross-sectional view of the vacuum nozzle.

### DETAILED DESCRIPTION

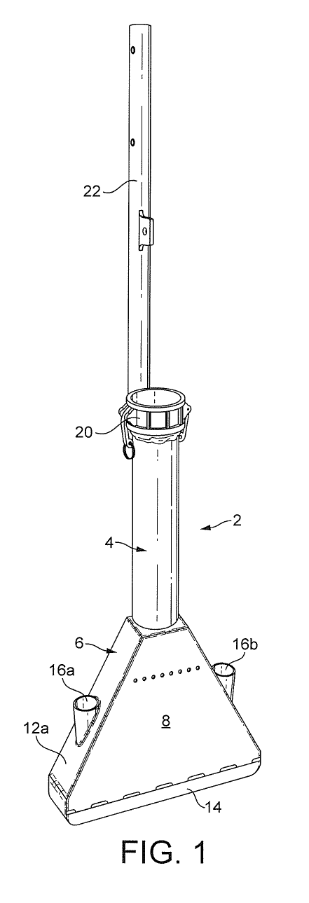

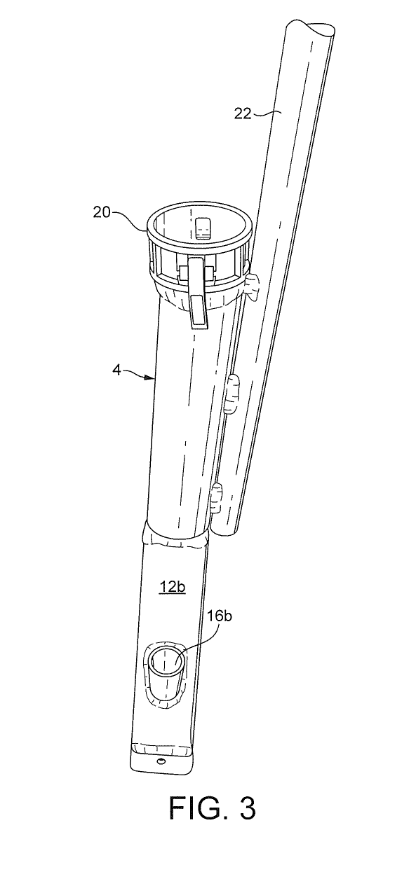

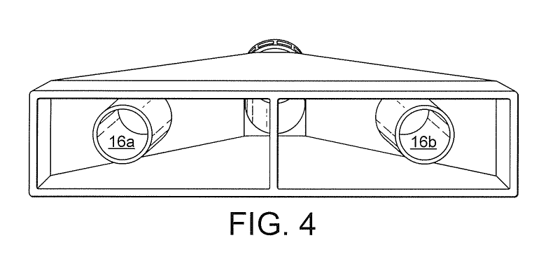

FIGS. 1 to 5 show a vacuum nozzle 2 according to an embodiment of the invention. As shown, the vacuum nozzle 2 comprises a vacuum conduit 4 which is fluidically connected to a head 6.

The head 6 is formed by front and rear walls 8, 10 and a pair of side walls 12a, 12b. The side walls 12a, 12b each have a shoulder portion and an end portion. The shoulder portion extends from the vacuum conduit 4 and the end portion is provided at the distal end of the side wall 12a, 12b. The shoulder portion forms the majority of the length of each side wall 12a, 12b. The shoulder portions diverge away from one another from the vacuum conduit 4, whereas the end portions lie parallel to one another. The front and rear walls 8, 10 are parallel to one another.

The head 6 thus has a rectangular cross-section (in a horizontal plane) which generally flares outwards (in a single plane i.e. widthwise) from the vacuum conduit 4. However, at the free, distal end, the head 6 has a uniform cross-section over the section bounded by the end portions of the side walls 12a, 12b. The head 6 forms a duckbill shape. At the distal end of the head 6, the front and rear walls 8, 10 and the side walls 12a, 12b form a rectangular inlet 14 which lies in a single plane.

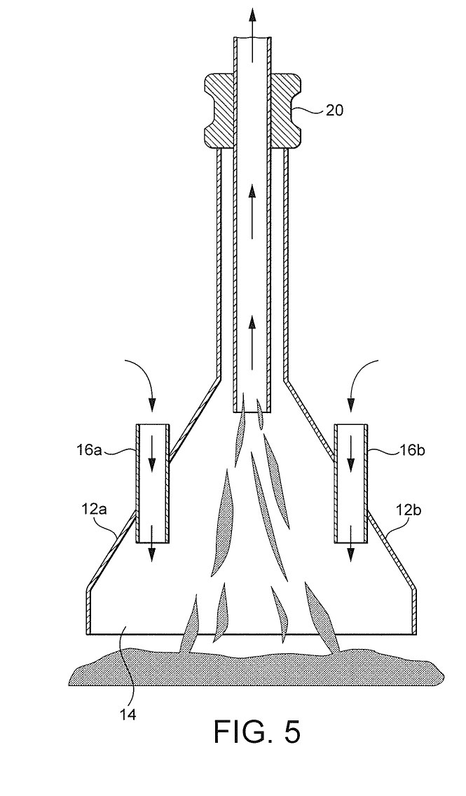

As shown particularly in FIG. 5, a fluidizing passage in the form of a tube 16a, 16b extends through the shoulder portion of each of the side walls 12a, 12b. The fluidizing tubes 16a, 16b are arranged such that their longitudinal axes are substantially parallel to that of the vacuum conduit 4. The fluidizing tubes 16a, 16b are offset to either side of the vacuum conduit 4. The fluidizing tubes 16a, 16b fluidically connect the interior of the head 6 to the exterior of the head 6.

The open end of each fluidizing tube 16a, 16b located within the interior of the head 6 forms an outlet and the opposite end located outside of the head 6 forms an inlet. The outlet of each fluidizing tube 16a, 16b is set back from the plane in which the inlet 14 of the head 6 lies. The inlet 14 may be considered to form a primary inlet to the vacuum nozzle 2 and the outlet of each fluidizing tube 16a, 16b may be considered to form a secondary inlet to the vacuum nozzle 2.

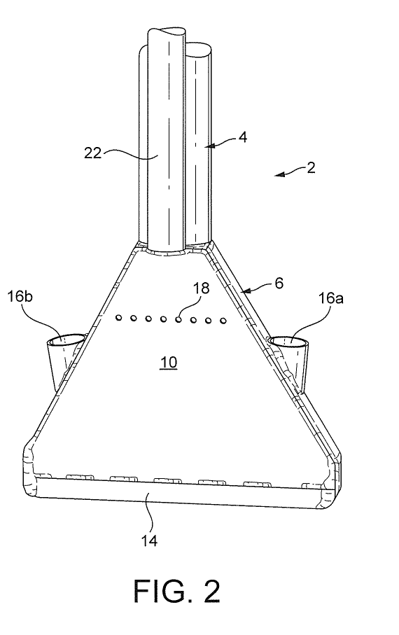

As shown particularly in FIGS. 1 and 2, the front and rear walls 8, 10 are each provided with a plurality of holes 18 which are spaced along the width of the head 6, adjacent the vacuum conduit 4. The holes 18 in the front wall 8 are aligned with the holes 18 in the rear wall 10. As a result, a bolt (not shown) can be passed through each pair of holes 18 between the front and rear walls 8, 10.

The distal end of the vacuum conduit 4 is provided with a cam and groove coupling 20 for connecting the vacuum nozzle 2 to a hose of a vacuum truck or the like. The vacuum nozzle 2 further comprises a handle 22 which is connected to the vacuum conduit 4. The handle 22 allows the vacuum nozzle 2 to be manipulated during use.

The dimensions of the vacuum nozzle 2 are sized to suit the application i.e. based on the pump and other site specific considerations. However, in the present embodiment, the head 6 has a length of approximately 16″ (40 cm), a width (between the end portions of the side walls 12a, 12b) at the inlet 14 of approximately 14″ (35 cm) and a thickness (between the front and rear walls 8, 10) of approximately 2.5″ (6 cm). The fluidizing tubes 16a, 16b have a diameter of approximately 1.5″ (4 cm). The total area of the fluidizing tubes 16a, 16b is therefore less than that of the inlet 14. Specifically, the ratio of the area of the inlet 14 to the total area of the fluidizing tubes 16a, 16b is approximately 10:1 in the present embodiment. It will be appreciated that the area of the fluidizing tubes 16a, 16b should be below that of the inlet 14 to ensure proper suction at the inlet 14.

In use, the vacuum nozzle 2 is connected to a hose of a vacuum truck or the like. The vacuum nozzle 2 is introduced into the sump of a tank and a pump of the vacuum truck provides suction to the vacuum nozzle 2 which causes solids from the sump to be drawn into the vacuum nozzle 2 through the inlet 14 (see FIG. 5). The solids are drawn through the hose to a disposal tank on the vacuum truck where they are stored for later disposal.

As described above, the inlet 14 may be considered to form a primary inlet to the vacuum nozzle 2 and the outlet of each fluidizing tube 16a, 16b may be considered to form a secondary inlet to the vacuum nozzle 2. As will be appreciated, the primary inlet formed by the inlet 14 and the secondary inlet formed by the fluidizing tubes 16a, 16b are oriented so as to substantially oppose one another. Therefore, the flow received by the fluidizing tubes 16a, 16b is directed towards the inlet 14. The fluidizing tubes 16a, 16b allow flow to be received by the vacuum nozzle, whilst bypassing the inlet 14.

The fluidizing tubes 16a, 16b ensure that the vacuum nozzle 2 does not lock to the floor of the sump during the pumping process. In particular, in free space, flow is preferentially directed into the vacuum nozzle 2 via the inlet 14, owing to its larger area. However, when the vacuum nozzle 2 approaches the floor of the sump, water begins to be drawn through the fluidizing tubes 16a, 16b (see FIG. 5) into the interior of the head 6, thereby providing a fluidizing action that prevents the vacuum nozzle 2 from sealing against the floor. Additionally, the fluidizing action has the added advantage of fluidizing the solids in the sump so as to break up grit that has solidified or agglomerated. Further, preventing the vacuum nozzle 2 sealing against the floor avoids damage to any equipment, such as diffusers, which are located on the floor of the sump.

The bolts inserted through the holes 18 act to screen larger debris or rags, thus preventing them from passing into the pump. This allows the rags to be quickly removed at the suction end rather than in the hose or pump which requires disassembly.

Although the vacuum nozzle 2 has been described as having a duckbill-shaped head 6, it will be appreciated that other arrangements may be used. In particular, the front and rear surfaces 8, 10 of the head 6 may also diverge from one another. Further, fluidizing tubes may be provided in a cylindrical nozzle.

The vacuum nozzle 2 may form part of the hose itself. For example, the fluidizing tubes may be formed directly in the side wall of the hose. The vacuum nozzle 2 may be used with other suction sources and is not limited to use with a vacuum truck.

The vacuum nozzle 2 may have any number of fluidizing tubes. Further, the fluidizing tubes may have any shape and need not be cylindrical. Moreover, the fluidizing tubes may be omitted and an opening simply provided in the wall of the vacuum nozzle 2. The tubular structure does, however, form a jet which is directed towards the inlet 14

The holes 18 may be omitted and instead a plurality of poles may be permanently connected between the front and rear walls 8, 10.

1. A vacuum nozzle for a vacuum pump or truck, the vacuum nozzle comprising:
a vacuum conduit configured to be connected to a vacuum source;
a primary inlet fluidically connected to the vacuum conduit for receiving flow under suction; and
a secondary inlet fluidically connected to the vacuum conduit for receiving flow under suction, the secondary inlet being positioned upstream of the primary inlet so as to allow flow to bypass the primary inlet, thereby preventing the primary inlet from sealing against a surface under suction.

2. A vacuum nozzle as claimed in claim 1, wherein the secondary inlet opens towards the primary inlet.

3. A vacuum nozzle as claimed in claim 2, wherein the secondary inlet is formed by a passage which extends towards the primary inlet.

4. A vacuum nozzle as claimed in claim 3, wherein the passage is substantially parallel to the vacuum conduit.

5. A vacuum nozzle as claimed in claim 1, wherein the area of the primary inlet is greater than the area of the secondary inlet.

6. A vacuum nozzle as claimed in claim 1, further comprising a head connected to the vacuum conduit, wherein a distal end of the head forms the primary inlet.

7. A vacuum nozzle as claimed in claim 6, wherein opposing side surfaces of the head diverge from one another from the vacuum conduit towards the distal end.

8. A vacuum nozzle as claimed in claim 7, wherein the secondary inlet is formed in one or both of the side surfaces.

9. A vacuum nozzle as claimed in claim 1, wherein the nozzle further includes a pair of secondary inlets.

10. A vacuum nozzle as claimed in claim 9, wherein the secondary inlets are offset either side of the vacuum conduit.

11. A vacuum nozzle as claimed in claim 6, further comprising one or more poles which extend across the head adjacent the vacuum conduit.

12. A vacuum nozzle as claimed in claim 11, wherein the poles are removably connected to the head.

13. A vacuum pump or truck comprising a nozzle as claimed in claim 1.
